(19) United States
(12) Patent Application Publication
(10) Pub. No.: US 2025/0377680 A1
(43) Pub. Date: Dec. 11, 2025

(54) SYSTEMS AND METHODS FOR INRUSH CURRENT CONTROL IN VOLTAGE REGULATORS

(71) Applicant: Avago Technologies International Sales Pte. Limited, Singapore (SG)

(72) Inventor: Wong Kian Tiong, Skudai (MY)

(21) Appl. No.: 18/890,133

(22) Filed: Sep. 19, 2024

Related U.S. Application Data
(60) Provisional application No. 63/656,680, filed on Jun. 6, 2024.

(51) Int. Cl. G05F 1/573; G05F 1/575

(52) U.S. Cl. CPC G05F 1/573; G05F 1/575

(57) ABSTRACT

The subject technology is directed to a device for managing inrush current in voltage regulation systems. The device includes an input configured to receive an input voltage and an output configured to provide an output voltage. The device includes a first circuit configured to generate a first signal associated with the output voltage. The device further includes a first comparator configured to compare the first signal with a first reference voltage and generate a second signal based on the comparison. The device further includes a switch configured to receive the second signal and adjust a first resistance in a current path between the input and the output based on the second signal. The device implements multi-level inrush current control, allowing for dynamic adjustment of the inrush current at different stages of the power-up phase.

### CROSS REFERENCE TO RELATED APPLICATIONS

This application claims priority to U.S. Provisional Application No. 63/656,680, filed Jun. 6, 2024, which is commonly owned and incorporated by reference herein for all purposes.

### BACKGROUND OF THE INVENTION

In modern electronic systems, voltage regulators are widely used to provide stable output voltages from varying input voltages. These regulators are important for powering sensitive components in devices such as microprocessors, memory modules, and communication interfaces. For example, low dropout (LDO) regulators are commonly used in such applications due to their ability to provide precise voltage regulation with minimal dropout voltage. However, managing inrush current during the power-up phase remains a significant challenge. Inrush current may refer to the initial surge of current that occurs when a power supply is first connected to a load or when a device is powered on. If not properly controlled, excessive inrush current can cause voltage overshoot, which may damage sensitive components or lead to system instability.

Some approaches for managing inrush current involve using output capacitors with large capacitance to absorb the initial surge or gradually ramping the reference voltage to control the rise of the output voltage. While these approaches may mitigate the risk of overshoot, they often introduce other challenges, such as increased cost, longer power-up times, and added system complexity.

Various approaches for controlling inrush current in voltage regulators have been explored, but they have proven to be insufficient. It is important to recognize the need for new and improved systems and methods for adaptive inrush current control in voltage regulators.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a circuit diagram illustrating a voltage regulator, in accordance with various embodiments of the subject technology.

FIG. 2 is a circuit diagram illustrating a voltage regulator, in accordance with various embodiments of the subject technology.

FIG. 3 is a circuit diagram illustrating a voltage regulator, in accordance with various embodiments of the subject technology.

FIG. 4 is a circuit diagram illustrating a voltage regulator, in accordance with various embodiments of the subject technology.

FIG. 5 is a graph illustrating a voltage and current plot of a voltage regulator during power-up, in accordance with various embodiments of the subject technology.

FIG. 6 is a graph illustrating a voltage and current plot of a voltage regulator during power-up, in accordance with various embodiments of the subject technology.

### DETAILED DESCRIPTION OF THE INVENTION

The subject technology is directed to a device for managing inrush current in voltage regulation systems. The device includes an input configured to receive an input voltage and an output configured to provide an output voltage. The device includes a first circuit configured to generate a first signal associated with the output voltage. The device further includes a first comparator configured to compare the first signal with a first reference voltage and generate a second signal based on the comparison. The device further includes a switch configured to receive the second signal and adjust a first resistance in a current path between the input and the output based on the second signal. The device implements multi-level inrush current control, allowing for dynamic inrush current adjustment throughout the power-up phase. This multi-level control prevents voltage overshoot, reduces stress on downstream components, and enhances the overall stability and reliability of the voltage regulator.

One aspect of the invention provides a device, which comprises an input configured to receive an input voltage and an output configured to provide an output voltage. The device further comprises a first circuit coupled to the output, the first circuit being configured to generate a first signal associated with the output voltage. The device further comprises a first comparator coupled to the first circuit, the first comparator being configured to compare the first signal with a first reference voltage and generate a second signal based on the comparison. The device further comprises a switch coupled to the comparator, the switch being configured to receive the second signal and adjust a first resistance in a current path between the input and the output based at least on the second signal.

In various embodiments, the device further comprises a first amplifier coupled to the switch, the first amplifier being configured to adjust an output current based at least on the second signal. The first circuit comprises a first resistor coupled to the output. The switch is configured to provide a first current limit in response to the output voltage being below the first reference voltage, and a second current limit in response to the output voltage being above the first reference voltage. The first current limit is higher than the second current limit. The current path comprises a second resistor coupled to the switch, and the switch is configured to adjust a second resistance of the second resistor. The device further comprises a delay circuit coupled to the switch, the delay circuit being configured to control an activation timing of the switch based at least on the second signal. The switch comprises a transistor. The device further comprises a second comparator coupled to the first circuit, the second comparator being configured to compare the first signal with a second reference voltage and generate a third signal based on the comparison.

Another aspect provides a device, which comprises an input configured to receive an input voltage and an output configured to provide an output voltage. The device further comprises a first circuit coupled to the output, the first circuit being configured to generate a first signal associated with the output voltage. The device further comprises a first comparator coupled to the first circuit, the first comparator being configured to compare the first signal with a first reference voltage and generate a second signal based on the comparison. The device further comprises a first switch coupled to the comparator, the first switch being configured to receive the second signal. The device further comprises a first resistor coupled to the first switch, the first switch is configured to adjust a first resistance of the first resistor based at least on the second signal.

In various embodiments, the device further comprises a first amplifier coupled to the first switch and the output, the first amplifier being configured to adjust an output current based at least on the second signal. The first circuit comprises a second resistor coupled to the output. The first switch is configured to provide a first current limit in response to the output voltage being below the first reference voltage, and a second current limit in response to the output voltage being above the first reference voltage. The first current limit is higher than the second current limit. The device further comprises a second comparator coupled to the first circuit, the second comparator being configured to compare the first signal with a second reference voltage and generate a third signal based on the comparison. a second comparator coupled to the first circuit, the second comparator being configured to compare the first signal with a second reference voltage and generate a third signal based on the comparison. The device further comprises a second switch coupled to the second comparator and the first resistor, the second switch is configured to adjust the resistance of the first resistor based at least on the third signal.

Yet another aspect provides a device, which comprises an output configured to provide an output voltage. The device further comprises a first circuit coupled to the output, the first circuit being configured to generate a first signal associated with the output voltage. The device further comprises a first comparator coupled to the first circuit, the first comparator being configured to compare the first signal with a first reference voltage and generate a second signal based on the comparison. The device further comprises a switch coupled to the comparator, the switch being configured to receive the second signal and adjust a resistance in a current path coupled to the output based at least on the second signal. In various embodiments, the switch is configured to provide a first current limit in response to the output voltage being below the first reference voltage, and a second current limit in response to the output voltage being above the first reference voltage. The first current limit is higher than the second current limit.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the subject technology is not intended to be limited to the embodiments presented but is to be accorded the widest scope consistent with the principles and novel features disclosed herein.

In the following detailed description, numerous specific details are set forth in order to provide a more thorough understanding of the subject technology. However, it will be apparent to one skilled in the art that the subject technology may be practiced without necessarily being limited to these specific details. In other instances, well-known structures and devices are shown in block diagram form, rather than in detail, in order to avoid obscuring the subject technology.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

When an element is referred to herein as being “disposed” in some manner relative to another element (e.g., disposed on, disposed between, disposed under, disposed adjacent to, or disposed in some other relative manner), it is to be understood that the elements can be directly disposed relative to the other element (e.g., disposed directly on another element), or have intervening elements present between the elements. In contrast, when an element is referred to as being “disposed directly” relative to another element, it should be understood that no intervening elements are present in the “direct” example. However, the existence of a direct disposition does not exclude other examples in which intervening elements may be present.

Moreover, the terms left, right, front, back, top, bottom, forward, reverse, clockwise and counterclockwise are used for purposes of explanation only and are not limited to any fixed direction or orientation. Rather, they are used merely to indicate relative locations and/or directions between various parts of an object and/or components.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the terms “including” and “having,” as well as other forms, such as “includes,” “included,” “has,” “have,” and “had,” should be considered non-exclusive. Also, terms such as “element” or “component” encompass both elements and components comprising one unit and elements and components that comprise more than one unit, unless specifically stated otherwise.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

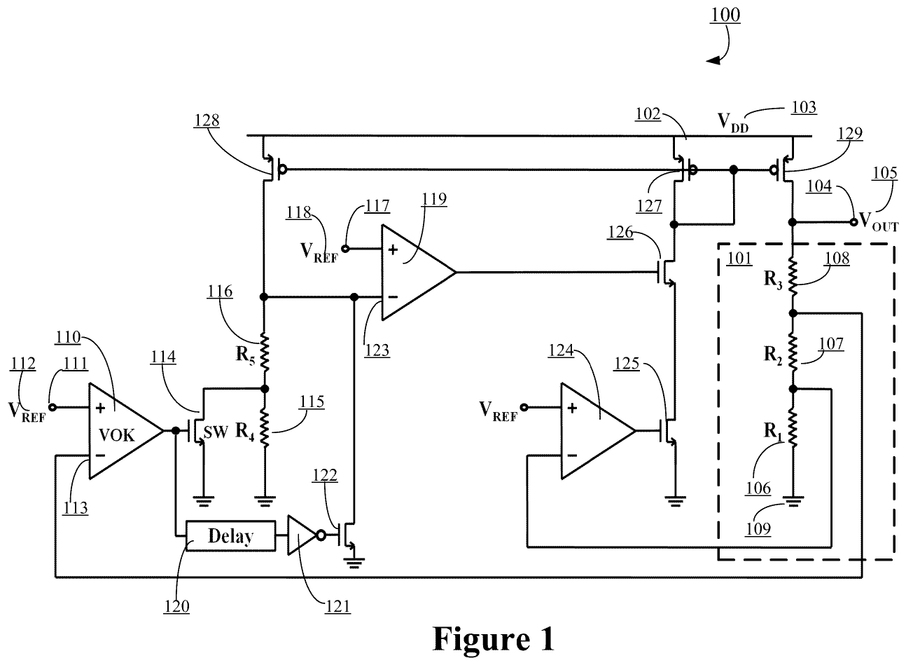

FIG. 1 is a circuit diagram illustrating a voltage regulator 100, in accordance with various embodiments of the subject technology. This diagram merely provides an example, which should not unduly limit the scope of the claims. One of ordinary skill in the art would recognize many variations, alternatives, and modifications. The term “voltage regulator” may refer to a device or circuit that maintains a constant output voltage regardless of changes in input voltage or load conditions. Examples of voltage regulators may include, without limitation, low dropout (LDO) regulators, switching regulators, linear regulators, and/or the like. Voltage regulators may be used in applications such as powering microprocessors, memory modules, communication interfaces, and other sensitive electronic components.

In various embodiments, voltage regulator 100 may be implemented as an LDO regulator, which is a type of linear regulator that maintains a constant output voltage with a very low voltage drop (e.g., less than 200 mV) between the input and output terminals. An LDO regulator may be configured to provide a stable and precise output voltage, even as the input voltage varies, or the load conditions change. This makes LDO regulators suitable for use in systems where power efficiency and low noise are required, such as in battery-powered devices, precision analog circuits, and sensitive digital components. In some implementations, voltage regulator 100 may incorporate an inrush current control mechanism to address the challenges associated with inrush current during the power-up phase. Inrush current can cause significant voltage overshoot, which may lead to instability in the output voltage and potentially damage sensitive components. Addressing inrush current is beneficial for ensuring the reliable operation and longevity of electronic systems.

As shown in FIG. 1, voltage regulator 100 may include input 102 and output 104. For instance, the term “input” may refer to a terminal or connection point within an electronic circuit that is configured to receive an electrical signal or power from an external source. Input 102 may be configured to receive input voltage 103 (e.g., V_{DD}). For example, input 102 may be coupled to a power supply source, such as a battery, power adapter, or other external voltage sources, providing the necessary input voltage for voltage regulator 100 to operate. The term “output” may refer to a terminal or connection point within an electronic circuit that is configured to deliver an electrical signal or power to an external load or subsequent stage of the circuit. Output 104 may be configured to provide output voltage 105 (e.g., V_{OUT}), which may be the regulated voltage generated by voltage regulator 100. Output 104 may be coupled to various loads or circuits, such as digital circuits, analog circuits, or other types of electronic circuitry.

In some embodiments, voltage regulator 100 includes first circuit 101 coupled to output 104. For instance, first circuit 101 may include a network of components within an electronic system that monitors the system's output and generates a signal that is fed back into the control circuitry to regulate and maintain the desired output. In some examples, first circuit 101 may be configured to monitor output voltage 105 and adjust the control mechanisms of voltage regulator 100 to maintain a constant and stable output, despite variations in input voltage 103 or load conditions.

First circuit 101 may be configured to generate a first signal associated with output voltage 105. For example, first circuit 101 includes a network of resistors that function together to generate a feedback signal corresponding to the output voltage. In various implementations, first circuit 101 includes one or more resistors (e.g., resistors 106, 107, 108) configured in series between output 104 and ground reference 109. This arrangement forms a voltage divider, which reduces output voltage 105 to a level that can be processed by the subsequent stage or control circuitry. The term “resistor” may refer to an electronic component that provides a specific amount of resistance to the flow of electrical current within a circuit. Examples of resistors may include, without limitation, fixed resistors, variable resistors, and/or the like. In some examples, resistors 106 and 107 are part of first circuit 101. These resistors create a voltage divider that produces the first signal, which is proportional to output voltage 105.

In various implementations, voltage regulator 100 includes comparator 110 coupled to first circuit 101. The term “comparator” may refer to an electronic device that compares two input voltages or signals and generates an output signal based on the comparison. Examples of comparators may include, without limitation, operational amplifiers, differential comparators, CMOS comparators, and/or the like. In some examples, comparator 110 may include input 111 coupled to a first reference voltage source (not shown) to receive first reference voltage 112 (e.g., VREF). The term “reference voltage” may refer to a stable, predefined voltage used as a benchmark for comparison in electronic circuits. Reference voltages may be generated by precision voltage references, zener diodes, bandgap reference circuits, or voltage regulator integrated circuits (ICs). For instance, first reference voltage 112 provides a fixed threshold that the first signal is compared against. In some examples, comparator 110 may further include input 113 coupled to first circuit 101 to receive the first signal.

Comparator 110 may be configured to compare the first signal generated by first circuit 101 with first reference voltage 112 and generate a second signal based on the comparison. The second signal may serve as a control signal that dictates the subsequent actions within voltage regulator 100. In some examples, the second signal may include a binary signal, which represents one of two possible states: high (e.g., logical “1”) or low (e.g., logical “0”). For instance, if the first signal (e.g., proportional to output voltage 105) is less than first reference voltage 112, comparator 110 may output a logic high signal, indicating output voltage 105 is below a certain threshold. Conversely, if the first signal is greater than first reference voltage 112, comparator 110 may output a logic low signal, indicating that output voltage 105 exceeds the desired threshold.

The second signal plays an important role in managing the inrush current during the power-up phase of voltage regulator 100 by controlling the resistance in the current path, thereby regulating the inrush current. The term “current path” may refer to an electrical pathway through which electrical current flows from the input to the output of a circuit. For instance, the current path of voltage regulator 100 may include various components (e.g., resistors, transistors, switches, etc.) that can be adjusted to modulate the amount of current reaching the output. By adjusting the resistance in the current path, the rate at which the output voltage rises during the power-up phase can be controlled effectively.

In some implementations, voltage regulator 100 includes switch 114 coupled to comparator 110. Comparator 110 may provide control signals (e.g., the second signal) that determine the state of switch 114. The term “switch” may refer to an electronic component that controls the flow of electrical current by opening or closing an electrical circuit. Examples of switches may include, without limitation, transistors, metal-oxide-semiconductor field-effect transistors (MOSFETs), relays, and/or the like. Switches can be used in various applications, from simple on/off control to complex circuit modulation and signal routing.

According to some embodiments, switch 114 may be configured to receive the second signal and adjust a first resistance in a current path between input 102 and output 104 based at least on the second signal. For instance, switch 114 may be coupled to one or more resistors (e.g., resistors 115 and/or 116) in a manner that allows it to control the inclusion or exclusion of these resistors in the current path. Switch 114 may be configured to adjust the resistance of resistors 115. For instance, resistors 115 and 116 may be part of the current path of voltage regulator 100 and can be selectively included or excluded from the current path depending on the state of switch 114. Resistor 116 may be coupled in series with resistor 115.

In various examples, switch 114 may be configured to provide a first current limit in response to output voltage 105 being below the first reference voltage 112, and a second current limit in response to output voltage 105 being above the first reference voltage. The first current limit may be higher than the second current limit. The term “current limit” may refer to the maximum allowable current that can flow through a circuit or component without causing damage or excessive stress. By adjusting the resistance in the current path using switch 114, the voltage regulator can effectively limit the inrush current during the power-up phase. This control mechanism prevents excessive current, thereby reducing the risk of voltage overshoot, potential damage to sensitive components, or instability in the regulated output voltage 105.

In operation, as voltage regulator 100 powers up, comparator 110 compares the first signal—which reflects the current output voltage—with first reference voltage 112. Based on the comparison, comparator 110 may generate the second signal, which dictates the state of switch 114. If the first signal is below first reference voltage 112, comparator 110 outputs a logic high signal, causing switch 114 to close. When switch 114 is closed, it bypasses resistor 115, reducing the overall resistance in the current path. This reduction in resistance allows a higher inrush current to flow, which rapidly charges the output capacitor, thereby increasing output voltage 105 more quickly to reach the desired level. As output voltage 105 approaches or exceeds first reference voltage 112, comparator 110 outputs a logic low signal, prompting switch 114 to open. When switch 114 opens, resistors 115 and/or 116 are included in the current path, increasing the resistance and thereby limiting the inrush current. This reduction in inrush current prevents the output voltage from overshooting the target level, ensuring a smooth transition to a stable and regulated voltage.

This mechanism provides a two-level inrush current control, where the first level allows for a higher inrush current to quickly charge the output capacitor during the initial power-up phase, and the second level reduces the inrush current as the output voltage approaches the target value. By dynamically switching between these two levels based on real-time feedback from comparator 110, voltage regulator 100 effectively balances the need for rapid power-up with the need to prevent voltage overshoot. This two-level inrush control not only enhances the efficiency of the power-up process but also ensures the protection of sensitive components and the overall stability of the system.

In some embodiments, voltage regulator 100 includes amplifier 119, which works in conjunction with the inrush current control mechanism to limit the inrush current, preventing the output capacitors from being overcharged and thereby avoiding output overshoot that could damage downstream circuitry. For instance, amplifier 119 may be coupled to switch 114. Amplifier 119 may be configured to limit the output current to the output capacitors. The term “amplifier” may refer to an electronic device or circuit that increases the power, voltage, or current of a signal. Examples of amplifiers may include, without limitation, operational amplifiers (op-amps), differential amplifiers, and/or the like.

In some examples, amplifier 119 includes an operational amplifier configured to regulate the output current to the output capacitors, which may be connected to output 104, by controlling the gate of transistor 126. For instance, amplifier 119 includes input 117 coupled to a second reference voltage source (not shown) to receive a second reference voltage 118 (e.g., VREF). Amplifier 119 may further include input 123 coupled to the inrush current control circuit (e.g., switch 114) and receive a feedback signal (e.g., the second signal). Amplifier 119 may be configured to adjust the output current limit based at least on the second signal. For example, amplifier 119 may be configured to compare the feedback signal with the second reference voltage 118. Based on this comparison, amplifier 119 may generate an output signal that controls the gate of transistor 126, which regulates the current flowing from input 102 to output 104. In some cases, voltage regulator 100 includes transistor 128 (e.g., which may also be referred to as a “sense element”). Sense element 128 may operate as a current-sensing device, providing real-time feedback on the current levels in the circuit. This information allows for adjusting the current limits during both the fast and slow charge phases of the inrush current control mechanism. By monitoring the current with sense element 128, the system can adjust the operation of transistors 126 to prevent excessive current flow. This regulation ensures there is no overcharge current on the output capacitors connected to output voltage 105, preventing output overshoot. The output voltage is regulated through the feedback mechanism involving first circuit 101, amplifier 124, transistor 125, ensuring stable output voltage regulation.

In various implementations, voltage regulator 100 includes delay circuit 120. The term “delay circuit” may refer to an electronic circuit designed to introduce a specific time delay in the propagation of signals within the system. Examples of delay circuits may include, without limitation, resistor-capacitor (RC) delay networks, digital delay lines, monostable multivibrators, and/or the like. In some examples, delay circuit 120 may be coupled to switch 114. Delay circuit 120 may be configured to control an activation timing of the switch based at least on the second signal. For example, delay circuit 120 may introduce a brief delay in the activation or deactivation of switch 114, allowing the system to gradually adjust the current path resistance and preventing abrupt changes in output voltage 105.

In some implementations, the output of delay circuit 120 may be coupled to inverter 121, which is configured to invert the signal before it is sent to the gate of transistor 122. The term “inverter” may refer to an electronic device that reverses the polarity of the input signal. The transistor 122 may act as a switching element and control the subsequent activation or deactivation of switch 114, based on the inverted signal from inverter 121. In some cases, delay circuit 120 may facilitate the transition to normal operation by ensuring that the switch does not activate or deactivate prematurely. This controlled delay helps to avoid sudden spikes or drops in current, which could otherwise destabilize output voltage 105.

In various embodiments, voltage regulator 100 includes amplifier 124, which is configured to regulate output voltage 105 by controlling the gate of transistor 125. For instance, amplifier 124 may include an operational amplifier. Amplifier 124 may include an input coupled to a third reference voltage source to receive a third reference voltage (e.g., VREF). Amplifier 124 may also include an input coupled to first circuit 101, allowing it to monitor and regulate output voltage 105 or other related signals. The output of amplifier 124 may be coupled to the gate of transistor 125, which acts as the second stage of voltage regulation within voltage regulator 100. In some examples, transistor 125 works in conjunction with transistor 127 (e.g., which may also be referred to as “PMOS diode”) and the transistor 129 (e.g., which may also be referred to as “PMOS pass element”) to regulate output voltage 105. For instance, transistor 125 acts as part of the second stage in the voltage regulation process, modulating the operation of transistors 127 and 129 to regulate output voltage 105. In various embodiments, pass element 129 may function as the control mechanism for the current flow between the input voltage 103 and the regulated output voltage 105. It operates in response to the control signals generated by the feedback loop, which is monitored and regulated by amplifier 124 and transistor 125.

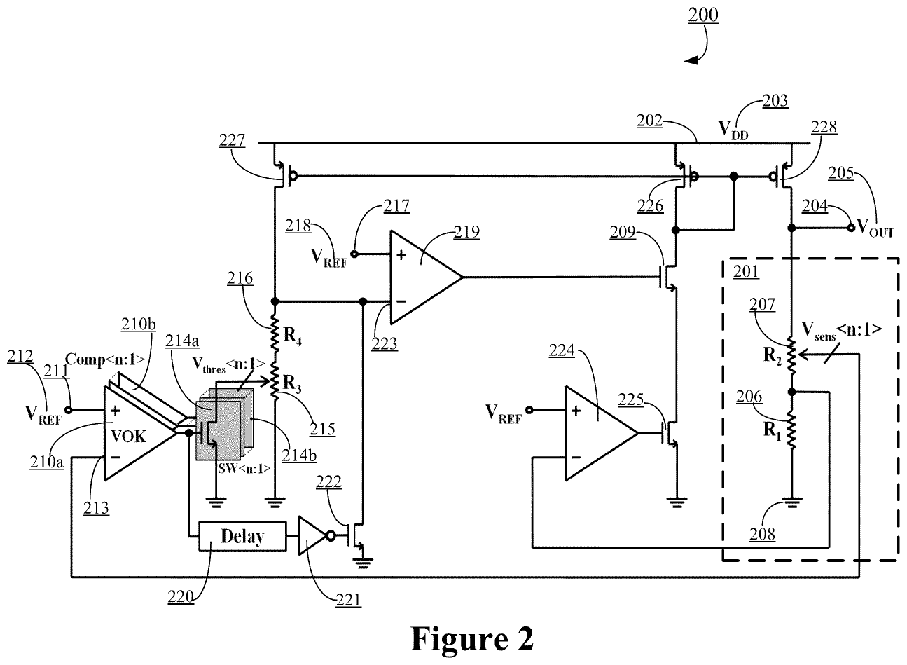

FIG. 2 is a circuit diagram illustrating a voltage regulator 200, in accordance with various embodiments of the subject technology. This diagram merely provides an example, which should not unduly limit the scope of the claims. One of ordinary skill in the art would recognize many variations, alternatives, and modifications. In various implementations, voltage regulator 200 may be implemented as an LDO regulator and may be used in applications requiring power efficiency and low noise, such as battery-powered devices and sensitive electronic components.

As shown in FIG. 2, voltage regulator 200 includes input 202 and output 204. Input 202 may be configured to receive input voltage 203 from an external power source. Output 204 may be configured to provide a regulated output voltage 205, which can be delivered to various loads or circuits, such as digital or analog circuitry. These loads may include, without limitation, microprocessors, memory modules, communication interfaces, or other sensitive electronic components.

Voltage regulator 200 may further include first circuit 201, which may be configured to monitor output voltage 205 and generate a first signal associated with output voltage 205. The first circuit may include a network of resistors (e.g., resistors 206 and 207) configured in series between output 204 and ground reference 208 to form a voltage divider. This voltage divider reduces output voltage 205 to a level suitable for further processing by control circuitry. In some examples, resistor 207 may include a variable resistor, which allows for adjustment of its resistance, providing flexibility in tuning the first signal. By varying the resistance of resistor 207, voltage regulator 200 can adjust the first signal, enabling it to implement different levels of inrush current control depending on the current state of output voltage 205.

According to various embodiments, voltage regulator 200 may include a plurality of comparators coupled to first circuit 201. These comparators may be configured to compare the first signal generated by first circuit 201 with one or more reference voltages and generate corresponding control signals. For instance, voltage regulator 200 may include a first comparator 210a and a second comparator 210b. Each comparator may include one or more inputs, such as input 211 for receiving a reference voltage 212 (e.g., VREF) and input 213 for receiving the first signal from first circuit 201. In some examples, comparator 210a may compare the first signal generated by first circuit 201 with a first reference voltage and generate a corresponding control signal (e.g., a second signal). Similarly, comparator 210b may compare the first signal with a different reference voltage and generate a corresponding control signal (e.g., a third signal), allowing for multiple levels of comparison.

In some implementations, the plurality of comparators may work in conjunction with a plurality of switches (e.g., switches 214a and 214b). The output of each comparator (e.g., 210a, 210b) may be used to control a corresponding switch, such as switches 214a and 214b. The plurality of switches may be coupled to resistors 215 and 216, allowing for the selective inclusion or exclusion of these resistors in the current path. Multiple comparators and switches enable voltage regulator 200 to implement a multi-level inrush current control mechanism, allowing voltage regulator 200 to adjust the inrush current at various stages of the power-up process, thereby preventing voltage overshoot and ensuring stable operation of the regulated output.

In various embodiments, the multi-level inrush current control mechanism operates by adjusting the current path resistance based on real-time feedback from the plurality of comparators. For instance, when output voltage 205 is low during the initial power-up phase, one or more comparators (e.g., comparators 210a, 210b) compare the first signal with their respective reference voltages. If the output voltage is below the thresholds set by these reference voltages, the corresponding comparators output logic high signals. These logic high signals activate the corresponding switches (e.g., switches 214a, 214b), which reduces the overall resistance in the current path by bypassing part of resistor 215, allowing a higher inrush current to flow. The high inrush current rapidly charges the output capacitor, quickly raising output voltage 205 to approach the desired level.

As output voltage 205 increases and approaches or exceeds the thresholds set by the reference voltages, the outputs of the comparators (e.g., 210a, 210b) may switch to logic low. The logic low signal may deactivate the corresponding switches, causing the resistors 215 and 216 to be included in the current path, thereby increasing the resistance and reducing the inrush current. By adjusting the resistance of resistor 215, a larger resistance is introduced into the circuit (e.g., R3+R4), slowing down the rise of the output voltage 205. This controlled reduction in inrush current ensures a smooth transition to the final regulated value of output voltage 205 without overshoot.

The multi-level inrush current limit control mechanism implemented by voltage regulator 200 allows for adaptive and precise management of inrush current during power-up. By dynamically adjusting the resistance in the current path at multiple stages, voltage regulator 200 can ensure a smooth and controlled transition to the target output voltage, protecting sensitive components and ensuring reliable operation across a range of operating conditions.

In various implementations, voltage regulator 200 includes amplifier 219. For instance, amplifier 219 may include input 217 coupled to a second reference voltage source to receive second reference voltage 218. Amplifier 219 may also include input 223 coupled to the output of the inrush current control circuit, allowing it to limit the inrush current, preventing the output capacitors from being overcharged and thereby avoiding output overshoot that could damage downstream circuitry. Amplifier 219 generates an output signal that controls the gate of transistor 209, regulating the current flowing from input 202 to output 204. In some cases, voltage regulator 200 includes transistor 227 (e.g., which may also be referred to as a “sense element”). Sense element 227 may operate as a current-sensing device, providing real-time feedback on the current levels in the circuit. This regulation ensures there is no overcharge current on the output capacitors connected to output voltage 205, preventing output overshoot.

In some embodiments, voltage regulator 200 includes delay circuit 220, which may be coupled to the plurality of switches (e.g., switches 214a and/or 214b). Delay circuit 220 may be configured to control an activation timing of the switch based at least on the second signal. For example, delay circuit 220 may introduce a brief delay in the activation or deactivation of the switches (e.g., switches 214a and/or 214b), allowing the system to gradually adjust the current path resistance and smoothly transition the output voltage 205 to its stable state. Inverter 221 may be configured to invert the output signal of delay circuit 220 before it is sent to the gate of transistor 222, which helps control the operation of the plurality of switches, ensuring a smooth transition to normal operation.

In various embodiments, voltage regulator 200 also includes amplifier 224, which is configured to regulate output voltage 205 by controlling the gate of transistor 209. Amplifier 224 may include an input coupled to a third reference voltage source to receive a third reference voltage. The output of amplifier 224 may be coupled to the gate of transistor 225, which acts as the second stage of voltage regulation within voltage regulator 200. In some examples, transistor 225 works in conjunction with transistor 226 (e.g., which may also be referred to as “PMOS diode”) and transistor 228 (e.g., which may also be referred to as PMOS pass element) to regulate output voltage 205.

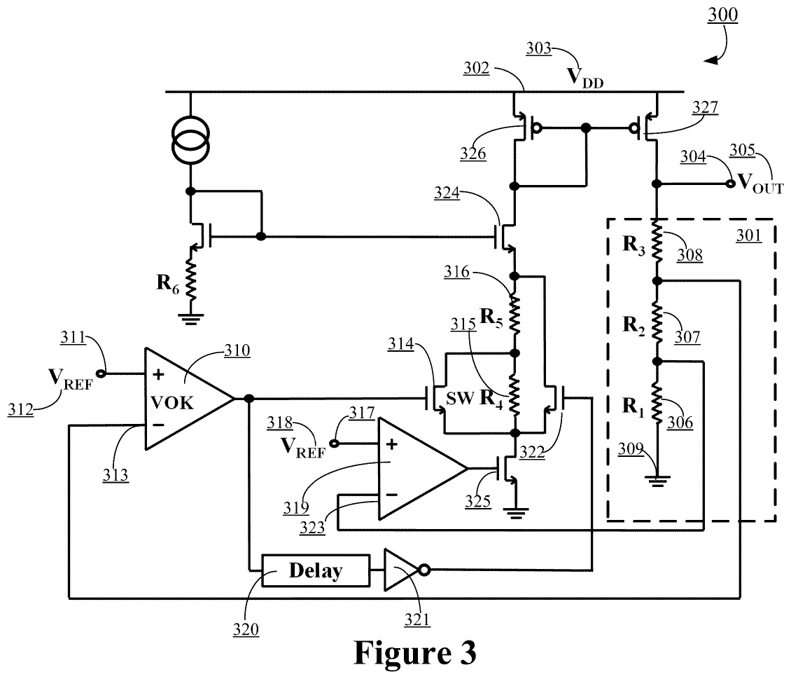

FIG. 3 is a circuit diagram illustrating a voltage regulator 300, in accordance with various embodiments of the subject technology. This diagram merely provides an example, which should not unduly limit the scope of the claims. One of ordinary skill in the art would recognize many variations, alternatives, and modifications. In various implementations, voltage regulator 300 may be implemented as an LDO regulator and may be used in applications requiring power efficiency and low noise, such as battery-powered devices and sensitive electronic components. Depending on the implementation, voltage regulator 100 may incorporate an inrush current control mechanism to address the challenges associated with inrush current during the power-up phase.

As shown, voltage regulator 300 may include input 302 and output 304. Input 302 may be configured to receive input voltage 303 (e.g., V_{DD}). For example, input 302 may be coupled to a power supply source, such as a battery, power adapter, or other external voltage sources, providing the necessary input voltage for voltage regulator 300 to operate. Output 304 may be configured to provide output voltage 305 (e.g., V_{OUT}), which may be the regulated voltage generated by voltage regulator 300. Output 304 may be coupled to various loads or circuits, such as digital circuits, analog circuits, or other types of electronic circuitry.

In some embodiments, voltage regulator 300 includes first circuit 301 coupled to output 304. For instance, first circuit 301 may be configured to monitor output voltage 305 and adjust the control mechanisms of voltage regulator 300 to maintain a constant and stable output, despite variations in input voltage 303 or load conditions. In some examples, first circuit 301 may be configured to generate a first signal associated with output voltage 305. For instance, first circuit 301 includes one or more resistors (e.g., resistors 306, 307, 308) configured in series between output 304 and ground reference 309. This arrangement forms a voltage divider, which reduces output voltage 305 to a level that can be processed by the subsequent stage or control circuitry. These resistors create a voltage divider that produces the first signal, which is proportional to output voltage 305.

In various implementations, voltage regulator 300 includes comparator 310 coupled to first circuit 301. In some examples, comparator 310 may include input 311 coupled to a first reference voltage source (not shown) to receive a first reference voltage 312 (e.g., VREF). For instance, first reference voltage 312 provides a fixed threshold that the first signal is compared against. In some cases, comparator 310 may further include input 313 coupled to first circuit 101 to receive the first signal.

Comparator 310 may be configured to compare the first signal generated by first circuit 301 with first reference voltage 312 and generate a second signal based on the comparison. The second signal may serve as a control signal that dictates the subsequent actions within voltage regulator 300. In some examples, the second signal may include a binary signal, which represents one of two possible states: high (e.g., logical “1”) or low (e.g., logical “0”). For instance, if the first signal (e.g., proportional to the output voltage) is less than first reference voltage 312, comparator 310 may output a logic high signal, indicating output voltage 305 is below a certain threshold. Conversely, if the first signal is greater than first reference voltage 312, comparator 310 may output a logic low signal, indicating that output voltage 305 exceeds the desired threshold.

In some implementations, voltage regulator 300 includes switch 314 coupled to comparator 310. Comparator 310 may provide control signals (e.g., the second signal) that determine the state of switch 314. In some examples, switch 314 may be coupled to one or more resistors (e.g., resistors 315 and/or 316), which are part of the current path of voltage regulator 300. Switch 314 may be configured to control the inclusion or exclusion of resistors 315 and/or 316 in the current path. For example, when switch 314 is closed (e.g., during the initial power-up phase when output voltage 305 is below first reference voltage 312), it effectively bypasses resistor 315, resulting in a lower overall resistance in the current path. This allows a higher inrush current to flow, enabling a faster charge of the output capacitor and a quicker increase in output voltage 305. As output voltage 305 approaches the desired level, comparator 310 outputs a logic low signal, causing switch 314 to open. This action includes resistors 315 and 316 in the current path, increasing the overall resistance and thereby limiting the inrush current. This reduction in current helps prevent overshoot of the output voltage and ensures a smooth transition to a stable regulated state.

To control output voltage, voltage regulator 300 may include amplifier 319. Amplifier 319 may include input 317 coupled to a second reference voltage source to receive second reference voltage 318. Amplifier 319 may also include input 323 coupled to first circuit 301, allowing it to monitor and regulate output voltage 305 or other related signals. Based on this comparison, amplifier 319 may generate a control signal that governs the operation of transistor 325. This configuration allows for fine-tuning the voltage regulation process, providing additional control over output voltage 305.

In various implementations, voltage regulator 300 includes delay circuit 320, which may be coupled to comparator 310 and/or switch 314. Delay circuit 320 may be configured to control an activation timing of switch 314 based at least on the second signal. For example, delay circuit 320 may introduce a brief delay in the activation or deactivation of switch 314, allowing the system to gradually adjust the current path resistance. The output of delay circuit 320 may then be inverted by inverter 321, which controls the gate of transistor 322. When transistor 322 is activated, it may short both resistors 315 and 316, minimizing the resistance in the current path and enabling voltage regulator 300 to transition into its normal operation mode.

In some embodiments, voltage regulator 300 may also include transistor 324, which may be coupled between input 302 and the current path leading to output 304. For example, transistor 324 may modulate the current delivered from input 302 to output 304. By adjusting the source voltage of transistor 324 with the biased voltage at its gate, voltage regulator 300 can adapt the current in response to varying load conditions or input voltage. In some examples, transistor 325 works in conjunction with transistor 326 (e.g., which may also be referred to as “PMOS diode”) and transistor 327 (e.g., which may also be referred to as “PMOS pass element”) to regulate output voltage 305.

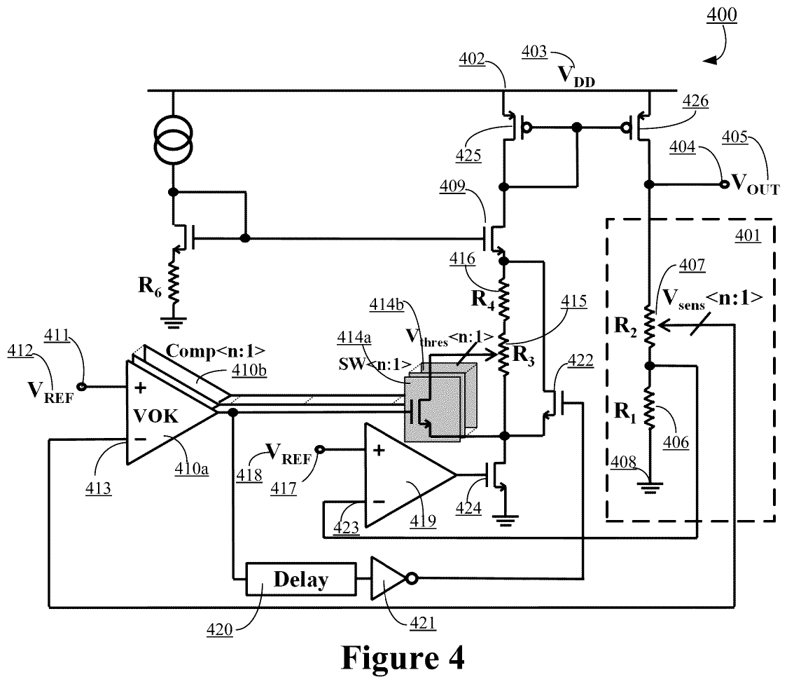

FIG. 4 is a circuit diagram illustrating a voltage regulator 400, in accordance with various embodiments of the subject technology. This diagram merely provides an example, which should not unduly limit the scope of the claims. One of ordinary skill in the art would recognize many variations, alternatives, and modifications. In various implementations, voltage regulator 400 may be implemented as an LDO regulator and may be used in applications requiring power efficiency and low noise, such as battery-powered devices and sensitive electronic components. Depending on the implementation, voltage regulator 400 may incorporate a multi-level inrush current control mechanism to address the challenges associated with inrush current during the power-up phase, as will be described in further detail below.

As shown, voltage regulator 400 may include input 402 and output 404. Input 402 may be configured to receive input voltage 403 (e.g., V_{DD}). For example, input 402 may be coupled to a power supply source, such as a battery, power adapter, or other external voltage sources, providing the necessary input voltage for voltage regulator 400 to operate. Output 404 may be configured to provide output voltage 405 (e.g., V_{OUT}), which may be the regulated voltage generated by voltage regulator 400. Output 404 may be coupled to various loads or circuits, such as digital circuits, analog circuits, or other types of electronic circuitry.

In some embodiments, voltage regulator 400 includes first circuit 401 coupled to output 404. First circuit 401 may be configured to monitor output voltage 405 and adjust the control mechanisms of voltage regulator 400 to maintain a constant and stable output, despite variations in input voltage 403 or load conditions. First circuit 401 may be configured to generate a first signal associated with output voltage 405. For instance, first circuit 401 includes one or more resistors (e.g., resistors 406, 407) configured in series between output 404 and ground reference 408. These resistors may form a voltage divider that produces the first signal, proportional to output voltage 405. In some examples, resistor 407 may include a variable resistor, which allows for adjustment of its resistance, providing flexibility in tuning the first signal. By varying the resistance of resistor 407, voltage regulator 400 can dynamically adjust the first signal, enabling it to implement different levels of inrush current control depending on the current state of output voltage 405.

According to various embodiments, voltage regulator 400 may include a plurality of comparators coupled to first circuit 401. These comparators may be configured to compare the first signal generated by first circuit 401 with one or more reference voltages and generate one or more control signals based on these comparisons. For instance, voltage regulator 400 may include a first comparator 410a and a second comparator 410b. Each comparator may include one or more inputs, such as input 411 for receiving reference voltage 412 (e.g., VREF) and input 413 for receiving the first signal from first circuit 401. In some examples, comparator 410a may compare the first signal generated by first circuit 401 with a first reference voltage and generate a corresponding control signal (e.g., a second signal). Similarly, comparator 410b may compare the first signal with a different reference voltage, allowing for multiple levels of comparison.

In some implementations, the plurality of comparators may work in conjunction with a plurality of switches (e.g., switches 414a and 414b). The output of each comparator (e.g., 410a, 410b) may be used to control a corresponding switch (e.g., 414a and 414b). The plurality of switches may be coupled to resistors 415 and 416, allowing for the selective inclusion or exclusion of these resistors in the current path. The presence of multiple comparators and switches enables voltage regulator 400 to implement a multi-level inrush current control mechanism.

The multi-level inrush current control mechanism operates by adjusting the current path resistance based on real-time feedback from the plurality of comparators. For instance, when output voltage 405 is low during the initial power-up phase, one or more comparators (e.g., comparators 410a, 410b) compare the first signal with their respective reference voltages. If the output voltage is below the thresholds set by these reference voltages, the corresponding comparators output logic high signals. These logic high signals activate the corresponding switches (e.g., switches 414a, 414b), which reduces the overall resistance in the current path by bypassing part of resistor 415, allowing a higher inrush current to flow. This high inrush current rapidly charges the output capacitor, quickly raising output voltage 405 to approach the desired level.

As output voltage 405 increases and approaches or exceeds the thresholds set by the reference voltages, the outputs of the comparators (e.g., 410a, 410b) may switch to logic low. The logic low signal may deactivate the corresponding switches, causing the resistors 415 and 416 to be included in the current path, thereby increasing the resistance and reducing the inrush current. By adjusting the resistance of resistor 415, the overall resistance is increased, thereby slowing down the rise of output voltage 405. This stepwise reduction in inrush current helps to prevent overshoot of the output voltage and ensures a smooth transition to a stable regulated state.

To control output voltage 405, voltage regulator 400 may include amplifier 419. Amplifier 419 may include input 417 coupled to a second reference voltage source to receive second reference voltage 418. Amplifier 419 may also include input 423 coupled to first circuit 401, allowing it to monitor and regulate output voltage 405 or other related signals. Based on this comparison, amplifier 419 may generate a control signal that governs the operation of transistor 424. This configuration allows for fine-tuning the voltage regulation process, providing additional control over output voltage 405.

In various implementations, voltage regulator 400 includes delay circuit 420, which may be coupled to the plurality of comparators (e.g., 410a, 410b) and/or the plurality of switches (e.g., 414a, 414b). Delay circuit 420 may be configured to control an activation timing of switch 414 based at least on the second signal. For example, delay circuit 420 may introduce a brief delay in the activation or deactivation of switch 414, allowing the system to gradually adjust the current path resistance and preventing abrupt changes in output voltage 405. The output of delay circuit 420 may be inverted by inverter 421, which then controls the gate of transistor 422. When transistor 422 is activated, it may short both resistors 415 and 416, effectively minimizing the resistance in the current path and allowing the voltage regulator to transition into its normal operation mode.

In some embodiments, voltage regulator 400 may also include transistor 409, which may be coupled between input 402 and the current path leading to output 404. For example, transistor 409 may control the current flow from input 402 to output 404. By adjusting the source voltage of transistor 409 with the biased voltage at its gate, voltage regulator 400 may modulate the current in response to changes in load conditions or input voltage, thereby maintaining a stable output voltage 405. In some examples, transistor 424 works in conjunction with transistor 425 (e.g., which may also be referred to as “PMOS diode”) and transistor 426 (e.g., which may also be referred to as PMOS pass element) to regulate output voltage 405.

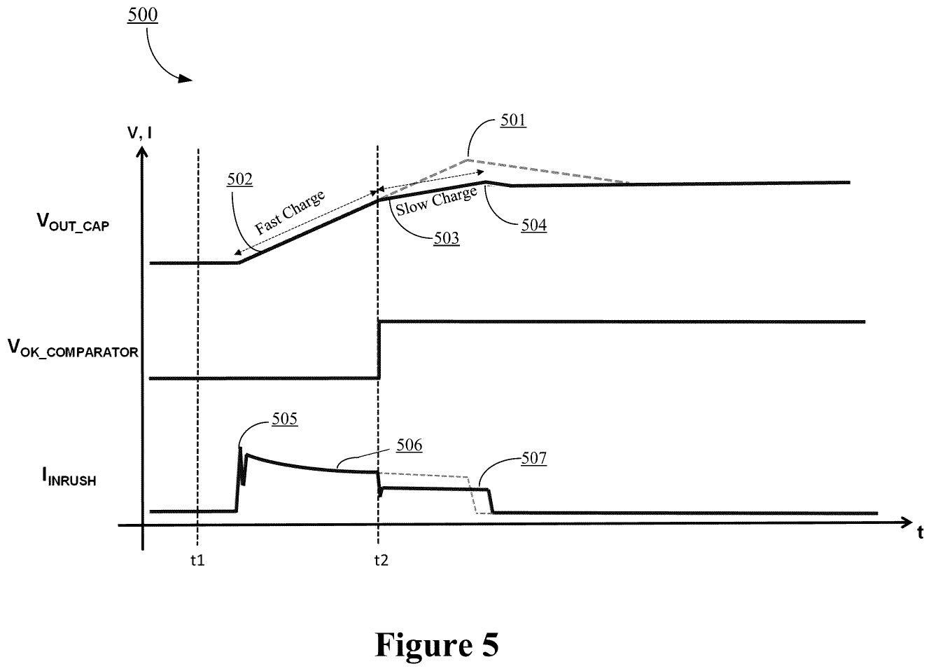

FIG. 5 is a graph illustrating a voltage and current plot 500 of a voltage regulator during power-up, in accordance with various embodiments of the subject technology. This diagram merely provides an example, which should not unduly limit the scope of the claims. One of ordinary skill in the art would recognize many variations, alternatives, and modifications. For instance, the graph includes three main plots: the output capacitor voltage V_{OUT_CAP}, the comparator output voltage V_{OK_COMPARATOR}, and the inrush current I_{INRUSH}. Each plot represents how these values change over time as the voltage regulator transitions from an off state to its normal operating condition. In some examples, the voltage regulator may operate with or without a two-level inrush current control mechanism, which is beneficial for managing the inrush current during power-up.

At time t1, when the voltage regulator begins the power-up process, the inrush current may exhibit an initial surge, as shown by the sharp increase in curve 505. This surge is due to the inrush current limit circuitry being activated, which may cause an overshoot in the inrush current I_{INRUSH}. Between t1 and t2, the output capacitor voltage V_{OUT_CAP} starts to rise from its initial low state, entering the fast charge phase represented by segment 502. During this phase, the voltage regulator allows a high current to flow to quickly charge the output capacitor.

As the output voltage V_{OUT_CAP} approaches a specific threshold, the inrush current I_{INRUSH} begins to decrease, as shown by segment 506, which corresponds to the first level of inrush current control. The first level of control may operate with a high current limit, allowing for rapid initial charging of the capacitor. In some implementations, the voltage regulator may employ a two-level inrush current control mechanism to refine the inrush current management. This mechanism helps to transition smoothly between different charging phases and avoids overshooting the output voltage.

At time t2, when the output voltage reaches a specific threshold as detected by the comparator, the comparator's output signal may switch from low to high, indicating that the output voltage is approaching the target level. At this point, the voltage regulator may transition from the fast charge phase to the slow charge phase, as represented by segment 503. During this phase, the inrush current is further reduced, entering the second level of inrush control with a lower current limit, as shown by segment 507. The gradual reduction in current ensures that the output voltage V_{OUT_CAP} stabilizes smoothly without exceeding the target voltage, minimizing the risk of overcharging, as indicated by segment 504.

Without a two-level inrush current control mechanism, as shown by the dashed line at segment 501, V_{OUT_CAP} would likely overshoot due to the higher single-level inrush current limit. This overshoot occurs because the inrush current limit circuitry may not respond quickly enough to reduce the current in time, leading to an overcharge of the output capacitor. This could potentially destabilize the voltage regulator and impact the overall performance of the system. It is to be appreciated that the two-level inrush current control mechanism provides an effective approach to managing the inrush current during the power-up phase, ensuring both stability and efficiency in the voltage regulation process.

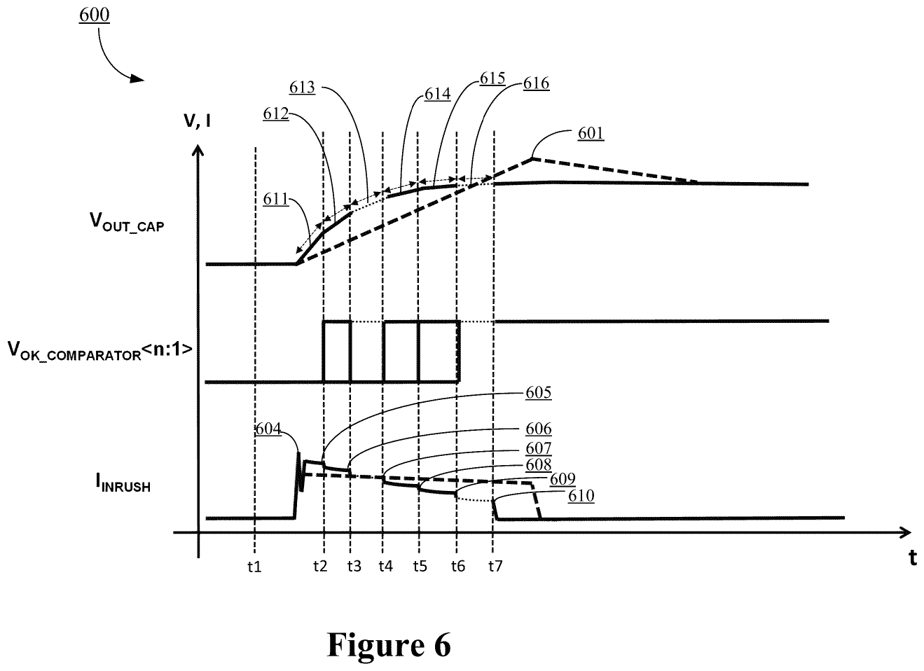

FIG. 6 is a graph illustrating a voltage and current plot 600 of a voltage regulator during power-up, in accordance with various embodiments of the subject technology. This diagram merely provides an example, which should not unduly limit the scope of the claims. One of ordinary skill in the art would recognize many variations, alternatives, and modifications. For instance, the graph includes three main plots: the output capacitor voltage V_{OUT_CAP}, the plurality of comparator output voltages V_{OK_COMPARATOR}<n:1>, and the inrush current I_{INRUSH}. Each plot represents how these values change over time as the voltage regulator transitions from an off state to its normal operating condition. In some examples, the voltage regulator may operate with or without a multi-level inrush current control mechanism, which is beneficial for managing the inrush current during power-up.

At time t1, when the voltage regulator begins the power-up process, the inrush current I_{INRUSH} may exhibit an initial surge, as shown by the sharp increase in curve 604. This surge occurs due to the inrush current limit circuitry being activated, which may cause an overshoot in the inrush current I_{INRUSH}. Between t1 and t2, the output capacitor voltage V_{OUT_CAP} starts to rise from its initial low state, entering a first fast charge phase represented by segment 611. During this phase, the voltage regulator allows a high current to flow to quickly charge the output capacitor.

As the output voltage V_{OUT_CAP} continues to increase, the inrush current I_{INRUSH} begins to decrease through a series of steps or levels, as shown by segments 611, 612, 613, and so on. Each of these segments corresponds to different levels of inrush current control, where the current is incrementally reduced as the voltage approaches its target level. For instance, segment 611 represents a first fast charge phase with the highest current limit, corresponding to a first level of inrush current control 605. This high current limit allows for rapid charging of the output capacitor. As the voltage regulator continues to monitor the output voltage, it transitions into a second fast charge phase, represented by segment 612. In this phase, the current is further reduced to a second level of inrush current limit, indicated by segment 606. As the charging process continues, the voltage regulator may enter additional fast charge phases, such as the n^{th} fast charge phase represented by segment 613. During this phase, the inrush current limit is further reduced to an n^{th} level, as indicated by segment 607. Each subsequent phase involves a progressively lower inrush current limit, allowing the output capacitor to charge in a controlled manner without risking overshoot. This multi-level approach ensures that the voltage regulator can efficiently and safely bring the output voltage to its desired level while minimizing the risk of instability or overcharging.

As the output voltage approaches a certain level (e.g., around time t4), the voltage regulator begins to transition from the fast charge phases to the slow charge phases, as shown by segments 614, 615, and 616. Each slow charge phase reduces the inrush current further, ensuring that the output voltage V_{OUT_CAP} stabilizes smoothly without exceeding the target voltage. For instance, segment 614 represents a first slow charge phase, where the inrush current is limited by a low current limit, corresponding to a first level of inrush current control, as indicated by segment 608. Following this, segment 615 represents a second slow charge phase, where the current limit is further reduced to a second level with a lower limit, as shown by segment 609. As the charging process continues, the voltage regulator may enter additional slow charge phases. Finally, the voltage regulator may enter an n^{th} slow charge phase, represented by segment 616, where the current limit reaches its lowest level, indicated by segment 610.

By incrementally reducing the inrush current through controlled stages, the voltage regulator can avoid the sharp transitions that often lead to overshoot and instability in the output voltage. This approach allows the output capacitor to charge more smoothly, ensuring that the voltage regulator achieves a stable and precise output without risking overcharging or damaging sensitive components. Additionally, the gradual reduction in current during the slow charge phases helps to extend the lifespan of the components by avoiding excessive stress during the power-up process.

Without a multi-level inrush current control mechanism, as shown by the dashed line at segment 601, V_{OUT_CAP} would likely overshoot due to the single-level inrush current limit. This overshoot occurs because the inrush current limit circuitry may not respond quickly enough to reduce the current in time, leading to an overcharge of the output capacitor. This could potentially destabilize the voltage regulator and impact the overall performance of the system. It is to be appreciated that the multi-level inrush current control mechanism provides an effective approach to managing the inrush current during the power-up phase, ensuring both stability and efficiency in the voltage regulation process.

While the above is a full description of the specific embodiments, various modifications, alternative constructions and equivalents may be used. Therefore, the above description and illustrations should not be taken as limiting the scope of the subject technology which is defined by the appended claims.

What is claimed is:

1. A device comprising:
an input configured to receive an input voltage;
an output configured to provide an output voltage;
a first circuit coupled to the output, the first circuit being configured to generate a first signal associated with the output voltage;
a first comparator coupled to the first circuit, the first comparator being configured to compare the first signal with a first reference voltage and generate a second signal based on the comparison; and
a switch coupled to the comparator, the switch being configured to receive the second signal and adjust a first resistance in a current path between the input and the output based at least on the second signal.

2. The device of claim 1, further comprising a first amplifier coupled to the switch, the first amplifier being configured to adjust an output current based at least on the second signal.

3. The device of claim 1, wherein the first circuit comprises a first resistor coupled to the output.

4. The device of claim 1, wherein the switch is configured to provide a first current limit in response to the output voltage being below the first reference voltage, and a second current limit in response to the output voltage being above the first reference voltage.

5. The device of claim 4, wherein the first current limit is higher than the second current limit.

6. The device of claim 1, wherein the current path comprises a second resistor coupled to the switch, and the switch is configured to adjust a second resistance of the second resistor.

7. The device of claim 1, further comprising a delay circuit coupled to the switch, the delay circuit being configured to control an activation timing of the switch based at least on the second signal.

8. The device of claim 1, wherein the switch comprises a transistor.

9. The device of claim 1, further comprising a second comparator coupled to the first circuit, the second comparator being configured to compare the first signal with a second reference voltage and generate a third signal based on the comparison.

10. A device comprising:
an input configured to receive an input voltage;
an output configured to provide an output voltage;
a first circuit coupled to the output, the first circuit being configured to generate a first signal associated with the output voltage;
a first comparator coupled to the first circuit, the first comparator being configured to compare the first signal with a first reference voltage and generate a second signal based on the comparison;
a first switch coupled to the comparator, the first switch being configured to receive the second signal; and
a first resistor coupled to the first switch, the first switch is configured to adjust a first resistance of the first resistor based at least on the second signal.

11. The device of claim 10, further comprising a first amplifier coupled to the first switch and the output, the first amplifier being configured to adjust an output current based at least on the second signal.

12. The device of claim 10, wherein the first circuit comprises a second resistor coupled to the output.

13. The device of claim 10, wherein the first switch is configured to provide a first current limit in response to the output voltage being below the first reference voltage, and a second current limit in response to the output voltage being above the first reference voltage.

14. The device of claim 13, wherein the first current limit is higher than the second current limit.

15. The device of claim 10, further comprising a second comparator coupled to the first circuit, the second comparator being configured to compare the first signal with a second reference voltage and generate a third signal based on the comparison.

16. The device of claim 15, further comprising a second switch coupled to the second comparator and the first resistor, the second switch is configured to adjust the resistance of the first resistor based at least on the third signal.

17. A device comprising:
an output configured to provide an output voltage;
a first circuit coupled to the output, the first circuit being configured to generate a first signal associated with the output voltage;
a first comparator coupled to the first circuit, the first comparator being configured to compare the first signal with a first reference voltage and generate a second signal based on the comparison; and
a switch coupled to the comparator, the switch being configured to receive the second signal and adjust a resistance in a current path coupled to the output based at least on the second signal.

18. The device of claim 17, wherein the switch is configured to provide a first current limit in response to the output voltage being below the first reference voltage, and a second current limit in response to the output voltage being above the first reference voltage.

19. The device of claim 18, wherein the first current limit is higher than the second current limit.

20. The device of claim 17, wherein the switch comprises a transistor.
